(19) United States
(12) Patent Application Publication
(10) Pub. No.: US 2016/0113202 A1
(43) Pub. Date: Apr. 28, 2016

(54) Cutting Blade

(71) Applicant: Dean Mayerle, Saskatoon (CA)

(72) Inventor: Dean Mayerle, Saskatoon (CA)

(21) Appl. No.: 14/835,232

(22) Filed: Aug. 25, 2015

Related U.S. Application Data
(60) Provisional application No. 62/068,109, filed on Oct. 24, 2014.

(51) Int. Cl. A01F 12/40; A01D 41/12

(52) U.S. Cl. CPC A01F 12/40; A01D 41/1243

(57) ABSTRACT

A straw chopper to be mounted at the rear discharge of a combine harvester includes a housing with a feed opening and a discharge opening with a rotor mounted in the housing for chopping and accelerating the crop materials. The rotor has a hub and a plurality of flail blade members where at least some of the blades are formed of a plate having a mounting hole through the plate for mounting on a bushing or pin of the rotor where a bearing surface of the mounting hole of the plate and not the plate surface is coated with material such as tungsten carbide or chromium carbide of a thickness less than 0.020 inches which is harder than a parent material of the plate.

This application claims the benefit under 35 USC 119(e) of Provisional Application 62/068109 filed Oct. 24, 2014.

This invention relates to a cutting blade for example for use in an apparatus for chopping and discharging straw from a combine harvester.

### BACKGROUND OF THE INVENTION

Many cutting machines use different styles of cutting blades which are free to pivot about their mounting hole. The blades operate in abrasive environments cutting residue, and wearing out quickly. Corn headers utilize cutting blades as shown in U.S. Pat. No. 8,402,727. Forage mowers utilize blades as shown in U.S. Pat. No. 8,307,620. Blade mowers utilize large swinging blades as shown in U.S. Pat. No. 5,626,007. Flail mowers use blades as shown in U.S. Pat. No. 7,930,872.

Combine harvesters harvest cereal grain crops, such as wheat, oats, rye, barley, corn, soybeans and flax. Grain and straw are separated in a combine harvester. Following the separation process, waste straw and chaff is supplied to a chopper for shredding and distributing back over the field in an even spread pattern.

In U.S. Pat. No. 6,840,854 issued Jan. 11, 2005 of Redekop is disclosed an apparatus for chopping and discharging straw from a combine harvester of the type which includes a plurality of blade members mounted on a hub for rotation about an axis of the hub with the blade members being arranged at spaced positions along the length of the hub substantially in radial planes of the hub so as to pass adjacent a plurality of axially spaced stationary blades again arranged in radial planes of the hub. The straw and other material discharged from the combine is fed into one side of the housing of the apparatus onto the hub and the material is carried around by the hub past the stationary blades in a chopping action. The material is then discharged from a discharge opening in the housing onto a tail board with spreading fins for spreading across the field.

A straw chopper, for example that in the above patent, typically contains blades carried on a rotor and stationary blades carried on the housing to cut the residue. During operation of the knives and particularly the knives of the rotor, the cutting edges wear out, which leads to a deterioration of the chopper operation, a change in the flow of the straw, reduced flow velocities and, at worst, a blockage of the chopper.

Different variations of chopper knives are known in the art. For instance, some arrangements of chopper knife can have two opposite cutting edges. This has the advantage that the knife can be inverted in case of wearing-out of a cutting edge oriented in the direction of rotation, thereby roughly doubling its lifespan.

In most cases the knife is mounted as a flail pivotally on a bushing or pin carried on the rotor so that the knife or blade is free to rotate relative to its mounting on the rotor. This allows the blade to recoil under impact and also helps to maintain balance of the rotor as the rotor rotates carrying a multitude of the blades arranged in an array around the axis of the rotor.

Thus for example the above patents show rotor blades which are defined by blades formed from a single flat sheet of metal which moves generally in the plane of the sheet where the front and rear edges are both sharpened.

In addition, as shown in the same patent, some blades may have a transverse portion out of the cutting plane for the purpose of acting as a fan blade to generate increased air flow. In this case only the front edge is sharpened.

In both cases the blade has a hole through a simple flat sheet portion of the blade at right angles to the plane of the sheet which defines a receptacle for the mounting bushing or pin.

Often farmers cut crop very close to the ground, incorporating dirt and rocks into the crop that is being fed into the combine. If the dirt is abrasive, this rapidly increases wear rates of the straw chopping blades.

The disclosures of all patents mentioned herein are incorporated herein by reference or may be referenced for further details not disclosed herein.

### SUMMARY OF THE INVENTION

According to a first aspect of the invention there is provided a blade for mounting on a rotor of a cutting machine, the blade comprising:

a plate having a mounting hole through the plate for mounting on a bushing or pin of the rotor having an axis at right angles to the plate;

the mounting hole being arranged to allow the blade to pivot about the mounting hole axis;

wherein a bearing surface of the mounting hole of the plate is coated with material harder than a parent material of the plate.

According to a second aspect of the invention there is provided a chopper and discharge apparatus arranged to be mounted at the rear discharge of a combine harvester for receiving the straw and/or chaff from the combine harvester and for discharging the materials from the combine harvester, the apparatus comprising:

a housing having a feed opening into which straw and/or chaff can be fed from the combine harvester and a discharge opening through which the chopped materials are discharged;

a chopping assembly mounted in the housing and comprising a hub member mounted for rotation about a longitudinal axis of the hub member and a plurality of blade members mounted on the hub member for rotation therewith about said axis for chopping the fed materials and accelerating the chopped materials for discharge;

at least some of the blades comprising:
a plate having a mounting hole through the plate for mounting on a bushing or pin of the rotor having an axis at right angles to the plate;
the mounting hole being arranged to allow the blade to pivot about the mounting hole axis;
wherein a bearing surface of the mounting hole of the plate is coated with material harder than a parent material of the plate.

Preferably at least one edge of the blade is sharpened so as to cut material as the edge rotates with the rotor as a leading edge of the blade. However the blade can also be one of a set where the blade is a fan blade rather than a cutting blade so that it has no cutting edge.

The term “sharpened” as used herein does not require any particular forming method such as grinding or honing and may relate to an edge which is merely reduced in cross-section. That is some blades have the leading edge formed in the stamping operation so that it is not sharp but wears sharp due to the use of a carbide coating. Other blades may be formed in a manner which does not form or sharpen the leading edge but use this as “good enough” so as to cut material as the edge rotates with the rotor as a leading edge of the blade.

Preferably the hole is circular cylindrical in shape.

Preferably the coating covers all of the surface of the hole.

Preferably the blade has the hole through a flat portion of the plate at right angles to the plane of the plate. However the hole can also be at an angle to the plate which can act to create airflow.

Preferably the blade is mounted as a flail pivotally on a bushing or pin carried on the rotor so that the blade is free to rotate relative to its mounting on the rotor.

Preferably the blade is arranged so as to form one of a multitude of the blades arranged in an array around the axis of the rotor.

In some cases the blade is a flat cutting blade formed from a single flat sheet of metal which moves generally in the plane of the sheet where the front and rear edges are both cutting edges which may sharpened.

In some cases the blade is a fan cutting blade formed from a single flat sheet of metal with a transverse portion of the blade out of the cutting plane for the purpose of generating air flow where the front edge is the cutting edge and may be sharpened.

In some cases the blade is a fan blade and has a transverse portion out of the radial plane for the purpose of acting as a fan blade to generate increased air flow where the front edge of the blade is not sharpened.

Preferably the blade has the hole through a simple flat sheet portion of the blade at right angles to the plane of the sheet which defines a receptacle for the mounting bushing or pin. Thus there is no additional component at the hole apart from the coating itself.

Preferably the blade has at least one cutting edge which is sharpened.

Preferably the coating is applied only to the surface of the hole and not on the surfaces of the plate. However it can be spread to a short distance over the surfaces of the plate itself.

Preferably the blade forms one of a set of blades wherein each has a coating on a hole thereof.

Preferably some of the cutting blades are formed from a single flat sheet of metal which moves generally in the plane of the sheet where the front and rear edges are both sharpened and some of the cutting blades have a transverse portion out of the cutting plane for the purpose of acting as a fan cutting blade to generate increased air flow.

Preferably the blades are arranged for use in a chopper and discharge apparatus arranged to be mounted at the rear discharge of a combine harvester for receiving the straw and/or chaff from the combine harvester and for discharging the materials from the combine harvester, the apparatus comprising:

a housing having a feed opening into which straw and/or chaff can be fed from the combine harvester;

a chopping assembly mounted in the housing and comprising a hub member mounted for rotation about a longitudinal axis of the hub member and a plurality of blade members mounted on the hub member for rotation therewith about said axis for chopping the fed materials and accelerating the chopped materials for discharge;

the housing having a discharge opening through which the chopped materials are discharged;

the housing and the chopping assembly being arranged such that the straw and/or chaff enters into the feed opening and discharges as a stream of crop material extending across the width of the housing and chopping assembly.

Preferably the chopping assembly comprises a center chopping section and two end fan sections, the blade members in the center chopping section and the two end fan sections being arranged such that an air flow generated thereby is driven radially outwardly by the blade members so as to exit from the housing radially outwardly from the blade members through the discharge opening, the blade members in the center chopping section being substantially all cutting blade members each of which is defined substantially by a planar cutting portion lying in a radial plane of the hub axis, the blade members in each of the fan sections being substantially all fan blade members each of which includes a fan blade portion arranged to extend outwardly to at least one axial side of the radial plane so as to generate an increased air flow relative to said flat blade members. However the blade can be used with other constructions of chopper.

The arrangement as described in detail hereinafter may provide a number of objectives including:

To provide a thin coating in the hole of the blade to increase the hardness of the surface of the hole in order to increase the overall life of the blade.

To provide a thin hard coating in the hole of the blade while the remainder of the material of the blade and around the blade hole remains ductile.

To provide a cutting blade where the hole of the blade lasts as long as the cutting edge of the blade.

In some conditions the hole of the blade will wear and therefore elongate before the cutting edge of the blade has worn significantly. The hole of the blade is typically hidden from operator view by the assembly bushings that hold the blade on the chopper making if difficult to determine the amount of wear in the chopper blade hole. When wear in the hole causes the hole to become over-sized relative to the mounting bushing or pin this allows dirt and residue to build up within the oversized hole. This can lead to the rotation of the flail on its bushing or pin to become seized which causes severe balance problems due to the high rotational speed of the chopper rotor. In some extreme examples this can ultimately result in the structural failure of the chopper housing and even the combine itself.

### BRIEF DESCRIPTION OF THE DRAWINGS

One embodiment of the invention will now be described in conjunction with the accompanying drawings in which:

FIG. 1 is an isometric view through of a straw chopper according to the present invention.

FIG. 2 is a side elevational view of the components of FIG. 1.

FIG. 3 is an isometric view of the components of FIG. 1 with the top cover removed.

FIG. 4 is cross-sectional view of the components of FIG. 1.

FIG. 5 is an exploded view of the rotor and blade components

FIG. 6 is a view of the typical mounting of cutting blades on a straw chopper rotor.

FIG. 7 is an isometric view of one of the fan cutting blades of FIGS. 1 to 4 showing the coating of the present invention and including a cutting edge.

FIG. 8 is a cross-sectional view along the lines 6-6 of FIG. 7.

FIG. 9 is an isometric view of one of the flat cutting blades of FIGS. 1 to 4 showing the coating of the present invention.

FIG. 10 is an isometric view of one of the fan blades 34 of FIGS. 1 to 4 which has no cutting edge showing the coating of the present invention.

In the drawings like characters of reference indicate corresponding parts in the different figures.

### DETAILED DESCRIPTION

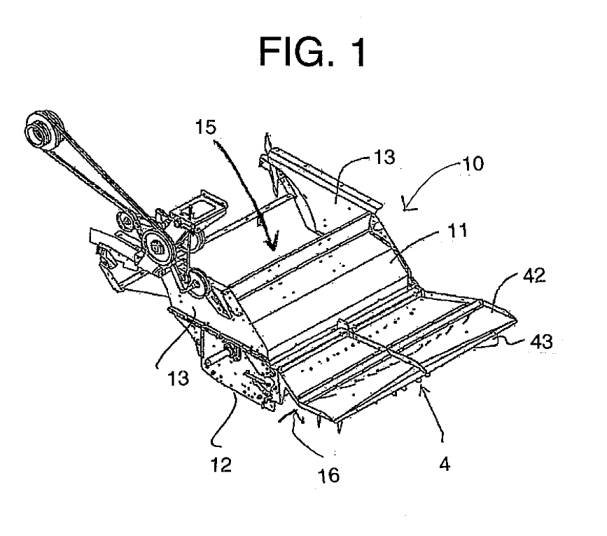

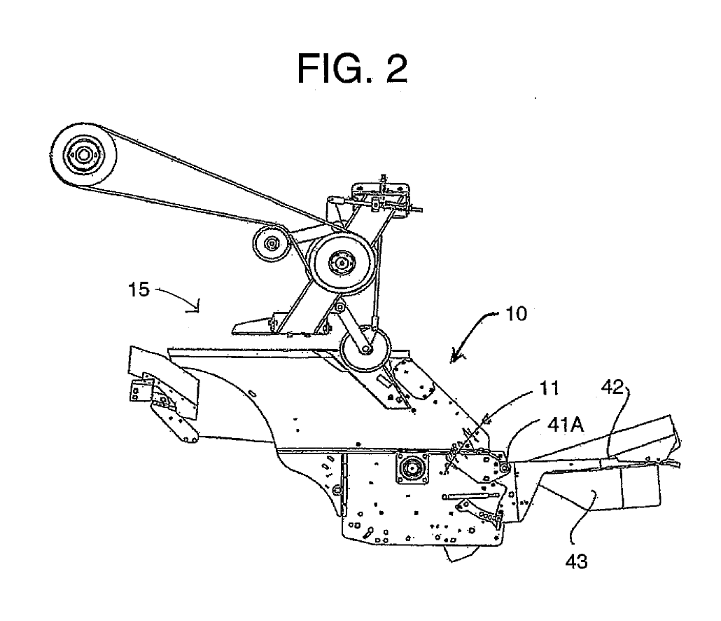

The chopper and discharge arrangement shown in FIGS. 1 to 4 is very similar to that from the prior patents of Redekop which are U.S. Pat. Nos. 5,232,405 and 5,482,508.

The apparatus which is basically as shown in U.S. Pat. No. 6,840,854 issued Jan. 11, 2005 of Redekop therefore comprises a housing 10 defined by a top wall 11, a bottom wall 12 and two side walls 13. The side walls 13 include attachment means schematically for attachment of the housing to the outlet of a combine harvester for discharge of straw and possibly chaff from the combine harvester into an inlet opening 15 of the housing 10. The bottom wall 12 defines a semi-cylindrical portion extending from the inlet 15 to an outlet 16 through which chopped straw and air is discharged at relatively high velocity for spreading across the field or for transportation into a container.

Within the housing is mounted a hub 17 which is carried on bearings 17A for rotation about a hub axis 18 at a center of the housing so that blade members 19 carried by the hub sweep around within the housing to entrap straw fed through the inlet 15 and to carry the straw and air past stationary blades 20 for chopping and for discharge through the outlet 16. The stationary blades 20 are mounted on the housing at a position between the inlet 15 and the outlet 16 so that the blade members 19 sweep between the stationary blades in a cutting action.

The hub 17 carries a plurality of lugs 21 at angularly and axially spaced positions therealong with each lug mounting a pair of blade members as described in more detail hereinafter for pivotal movement of the blade members about a bushing or pin 51 parallel to the axis 18.

The lugs 21 can be arranged in a spiral pattern around the hub 17. Each of the lugs carries a pair of blade members. Each lug is aligned with a respective one of the stationary blades 20 so that each stationary blade has associated with it a respective one of the lugs and thus has associated with it the pair of blades carried by that lug. Each stationary blade is thus swept by the blade members once for each rotation of the hub with some of the stationary blades being swept at each of the four 90° positions of rotation of the hub.

In this arrangement of the chopper, there is provided three sections of the chopper assembly including a first fan section 30 at one end of the hub 17 and the second fan section 31 at the other end of the hub 17. In-between the two narrow fan sections is defined a center section which provides the whole of the cutting action.

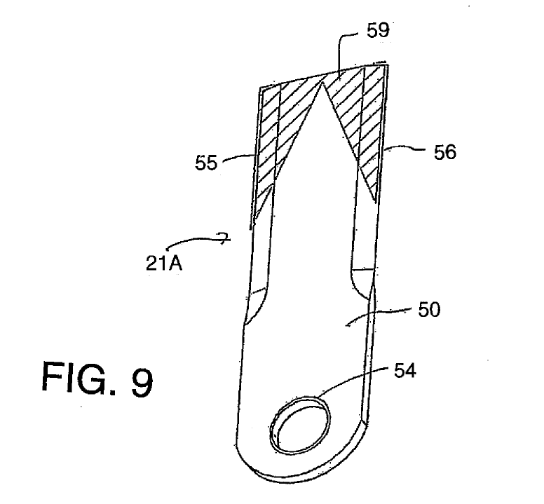

Within the center section all or substantially all of the blades are formed with a cutting edge lying in a radial plane of the axis 18. The blades are either a flat cutting blade type with a leading a trailing chamfered edge as best shown in FIG. 9, or a fan cutting blade with a transverse portion of the blade out of the cutting plane with a leading cutting edge as shown in FIG. 7. Thus each of the two flail blades 21A and/or 21B in the center section can pass closely on either side of a respective one of the stationary blades. Thus the stationary blades can be spaced by a distance which is just sufficient to allow the passage therebetween of a flat cutting blade 21A. The spacing between the stationary blades thus can be significantly reduced with flat cutting blades, however if additional airflow is required a fan cutting blade may be used with a corresponding change in spacing of the stationary blades.

In the fan sections 30 and 31, there is provided a ring 33 which is mounted on the hub 17 at a respective end of the hub. The ring thus surrounds the cylindrical wall of the hub and stands outwardly therefrom just beyond the end of the center section defined by the stationary blades and the blades 21 carried on the hub.

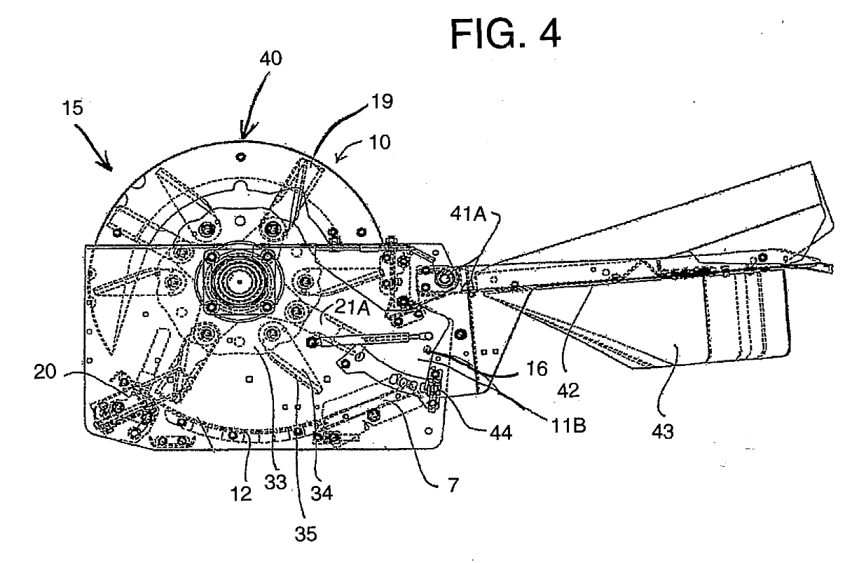

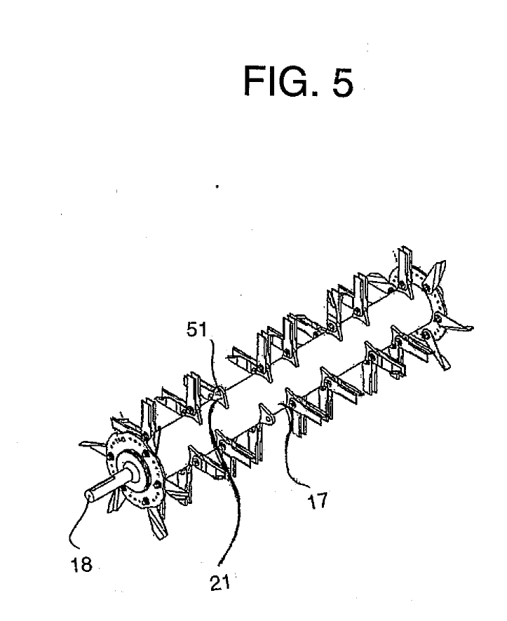

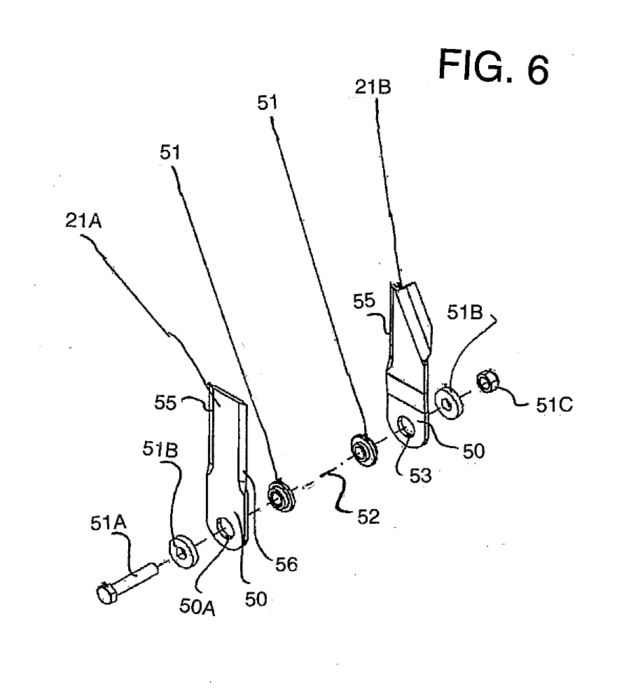

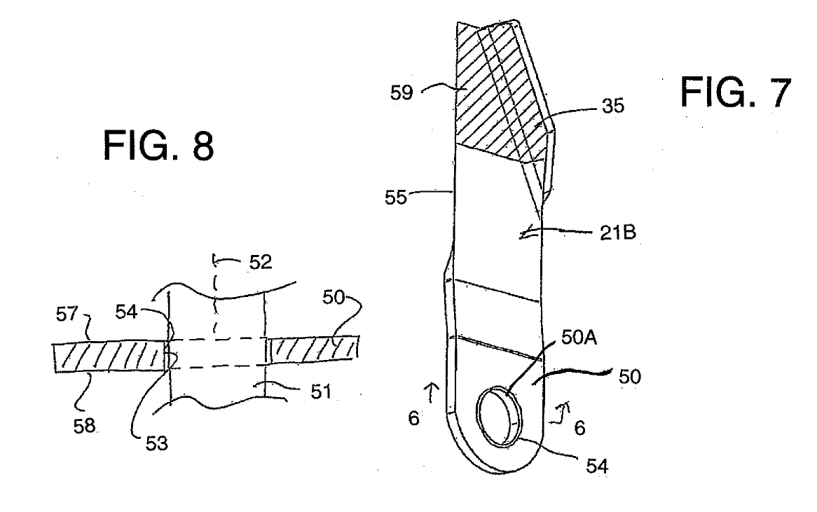

The rings 33 each carry a plurality of fan blades 34 at spaced positions around the ring. The fan blades 34 are arranged thus so that each follow directly behind the next at the same axial location and there is no staggering of the fan blades 34. There are six such fan blades as shown in FIG. 4 so that the spacing between them angularly of the hub is reduced relative to the 90 degree spacing of the cutting blades.

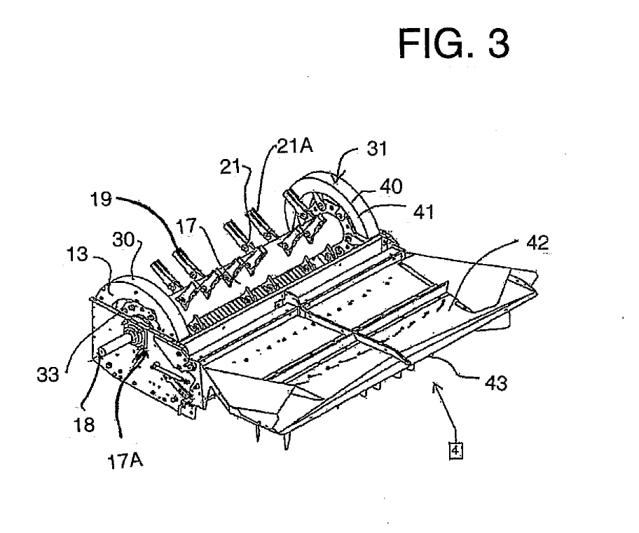

Each of the fan blades 34 is bent with a fan blade portion 35 so that each of the fan blades is of the shape shown in FIG. 3 of the U.S. Pat. No. 5,482,508 of Redekop. However the fan blades 34 do not necessarily have a sharp leading edge since there is intended to be no cutting action in the fan section. Thus the fan blades are spaced from the end most stationary blade so that in effect no cutting action occurs in this section.

The bent fan blade portion stands outwardly to one side of the flat plate portion of the fan blade. The fan blade portion which is bent at right angles to the main body of the fan blade is maximised in dimension so that it may be rectangular. This large blade area together with the presence of the six blades generates a significant air flow.

There is no baffle or other elements within the housing or on the chopper assembly to prevent air flow or material flow axially between the center section and the fan sections. The mounting ring 33 is only slightly greater in dimension than the hub so that it does not significantly interfere with the air flow between the hub and the housing since the majority of the air flow is around the outside of the housing where the fan blades are at their most effective.

The fan blade portion is inclined forwardly and outwardly so that at a regularly outer position toward the outer end of each fan blade the fan blade portion is angularly advanced relative to its position closer to the axis of the hub. This incline outwardly and forwardly significantly increases the air flow effect driving the air in the greater volume and at higher speed radially from the fan section and outwardly of the exit 16.

Preferably the fan section comprises only a single row of the six fan blades but in some cases an additional row or rows may be provided although this is not preferred. The fan blades are arranged immediately adjacent the side walls 13 so that they take up minimum space at the end of the chopper assembly. It will be appreciated that the intention is to provide maximum air flow in the fan sections while taking up minimum dimensions so that the maximised chopping effect to provide shortest material is achieved within the center section using the flat cutting blades.

Just at the fan section, the housing provides a cover wall 40 which is a semi-cylindrical narrow wall having an inner edge 41 at the intersection between the center section and the fan section and an outer edge abutting or attached to the outer wall 13. This cover panel thus reduces the amount of feed material which enters the fan section although of course this is not precluded in view of the fact that the material can flow axially from a position at the flat blades into the fan section due to the tendency for the fan section to draw air axially outwardly at the inlet and to drive air axially inwardly at the outlet.

In operation, the very high velocity of air from the fan section exiting radially outwardly from the exit discharge 16 occurs not only at the fan section but also extends partly into the width of the center section so that approximately 12 to 15 inches of the center section has a velocity at the exit which can be greater than 75 ft/s.

The above arrangement of chopper is one example only of arrangements which can be used herein.

The arrangement disclosed herein therefore provides fan blades 34 or cutting blades 21A and 21B for mounting on a rotor or hub 13 of a cutting machine.

In each case the blade includes a plate 50 having a mounting hole 50A through the plate for mounting on a bushing 51 carried on a pin 51A of the rotor 13 having an axis 52 at right angles to the plate 50. The pin 51A carries washers 51B and a nut 51C. The mounting hole 50A is arranged to allow the blade to pivot about the mounting hole axis 52 on the bushing 51. In some cases the bushing 51 is omitted and the hole 50A directly surrounds the pin 51A. The circular cylindrical bearing surface 53 of the mounting hole 50A of the plate 50 is coated with a layer 54 of material harder than a parent material (typically steel) of the plate 50.

The bushing provides a collar which engages into the hole in the plate. However even using the bushing, where the hole is not lined with the coating as in the present invention, wear can occur at the hole with the above problems arising.

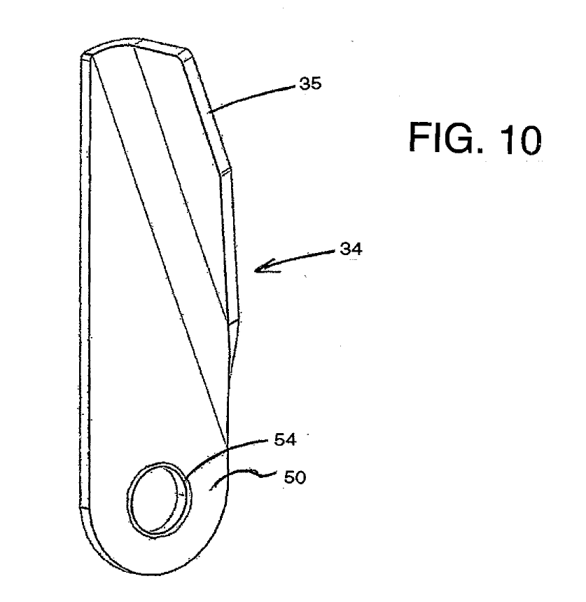

In each of FIGS. 7 and 9 at least one edge 55 of the blade is sharpened so as to cut material as the edge rotates with the rotor as a leading edge of the blade. In FIG. 9 the rear edge 56 is also sharpened. In FIG. 7 the blade includes the flange 35 which projects out of the plane of the plate 50 to generate air flow. This is typically formed by bending but can be welded in place. In FIG. 10 the blade has no sharpened edge and may include a larger flange for air flow generation.

The coating 54 covers all of the cylindrical surface of the hole but does not extend onto the surface 57 or 58 of the plate 50.

The blade is mounted as a flail pivotally on the bushing 51 or pin 51A carried on the rotor so that the blade is free to rotate relative to its mounting on the hub 13.

As shown in FIG. 10, the blade 34 has a transverse portion 35 out of the cutting plane for the purpose of acting as a fan blade to generate increased air flow where the front edge of the blade is not sharpened.

The blade has the cutting edge or edges of the chopper knives which may be hardened by a heat treatment process and preferably enhanced by a coating 59.

The cylindrical coating layer 54 in the cylindrical hole 53 forms a layer containing for example tungsten carbide or chromium carbide coating with a thickness less than 0.020 inches. The coating may be in the hardness range of 65 Rockwell C while the blade material may be 40 to 52 Rockwell C

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A blade for mounting on a rotor of a cutting machine, the blade comprising:
a plate having a mounting hole through the plate for mounting on a bushing or pin of the rotor;
the mounting hole being arranged to allow the blade to pivot about an axis of the mounting hole;
wherein a bearing surface of the mounting hole of the plate is coated with material harder than a parent material of the plate.

2. The blade according to claim 1 wherein at least one edge of the plate is sharpened.

3. The blade according to claim 1 wherein the hole is circular cylindrical in shape.

4. The blade according to claim 1 wherein the coating covers all of the surface of the plate at the hole.

5. The blade according to claim 1 wherein the blade is mounted as a flail pivotally on a bushing or pin carried on the rotor so that the blade is free to rotate relative to the bushing or pin on the rotor.

6. The blade according to claim 1 wherein the blade is formed from a single flat sheet of metal defining the plate where the front and rear edges of the plate are both sharpened.

7. The blade according to claim 1 wherein the blade has a transverse portion bent out of a plane of the plate where only a front edge of the plate is sharpened.

8. The blade according to claim 1 wherein the blade has the hole through a flat portion of the plate at right angles to the plane of the plate.

9. The blade according to claim 1 wherein the blade has at least one cutting edge which is harder than a parent material of the plate.

10. The blade according to claim 1 wherein the coating is applied only to the surface of the hole and not on the surfaces of the plate.

11. The blade according to claim 1 wherein the coating contains tungsten carbide or chromium carbide.

12. The blade according to claim 1 wherein the coating has a thickness less than 0.020 inches.

13. A chopper and discharge apparatus arranged to be mounted at the rear discharge of a combine harvester for receiving the straw and/or chaff from the combine harvester and for discharging the materials from the combine harvester, the apparatus comprising:
a housing having a feed opening into which straw and/or chaff can be fed from the combine harvester and a discharge opening through which the chopped materials are discharged;
a chopping assembly mounted in the housing and comprising a hub member mounted for rotation about a longitudinal axis of the hub member and a plurality of blade members mounted on the hub member for rotation therewith about said axis for chopping the fed materials and accelerating the chopped materials for discharge;
at least some of the blades comprising:
a plate having a mounting hole through the plate for mounting on a bushing or pin of the rotor;
the mounting hole being arranged to allow the blade to pivot about an axis of the mounting hole;
wherein a bearing surface of the mounting hole of the plate is coated with material harder than a parent material of the plate.

14. The apparatus according to claim 13 wherein the chopping assembly comprises a center chopping section and two end fan sections, the blade members in the center chopping section and the two end fan sections being arranged such that an air flow generated thereby is driven radially outwardly by the blade members so as to exit from the housing radially outwardly from the blade members through the discharge opening, the blade members in the center chopping section being substantially all cutting blade members, the blade members in each of the fan sections being substantially all fan blade members each of which includes a fan blade portion arranged to extend outwardly to at least one axial side of the radial plane so as to generate an increased air flow relative to said cutting blade members.

15. The apparatus according to claim 14 wherein the chopping blades are formed from a single flat sheet of metal defining the plate where the front and rear edges of the plate are both sharpened.

16. The apparatus according to claim 14 wherein the fan blades blade each have a transverse portion bent out of a plane of the plate where only a front edge of the plate is sharpened.

17. The apparatus according to claim 13 wherein the coating covers all of the cylindrical surface of the plate at the hole.

18. The apparatus according to claim 13 wherein the coating is applied only to the surface of the hole and not on the surfaces of the plate.

19. The apparatus according to claim 13 wherein the coating contains tungsten carbide or chromium carbide.

20. The apparatus according to claim 13 wherein the coating has a thickness less than 0.020 inches.
